(19) United States
(12) Patent Application Publication
(10) Pub. No.: US 2025/0140988 A1
(43) Pub. Date: May 1, 2025

(54) Cell Module With a Plurality of Cell Packs and Heat-Resistant Barrier Between the Cell Packs

(71) Applicant: Bayerische Motoren Werke Aktiengesellschaft, Muenchen (DE)

(72) Inventors: Andre HECKERT, Muenchen (DE); Simon LUX, Muenster (DE); Florian REDL, Unterfoehring (DE); Alexander RHEINFELD, Muenchen (DE); Robin RUECKER, Schaeftlarn (DE); Andreas SCHLEICHER, Erdweg (DE); Sebastian SPIRKL, Muenchen (DE)

(21) Appl. No.: 18/835,455

(22) PCT Filed: Feb. 27, 2023
(86) PCT No.: PCT/EP2023/054773

§ 371 Date: Aug. 2, 2024

(30) Foreign Application Priority Data
Mar. 25, 2022 (DE) 10 2022 107 099.9

(51) Int. Cl. H01M 10/658; H01M 50/264

(52) U.S. Cl. CPC H01M 10/658; H01M 50/264; H01M 2220/20

(57) ABSTRACT

A cell module for an electrical energy store of a motor vehicle includes at least two cell packs that are connected together and each have a plurality of interconnected storage cells, a cell module frame having at least two frame portions arranged adjacent to one another each for receiving one cell pack, a cover arranged on the cell module frame for covering the frame portions, and at least one heat-resistant firewall-type barrier arranged on the cover to overlap a transition between the two cell packs. The barrier is designed to divide a space adjacent to the cover into at least two fire compartments in order to prevent hot gas of a cell pack that is flowing into the space from spreading to an adjacent cell pack.

### BACKGROUND AND SUMMARY

The invention relates to a cell module for an electrical energy store of a motor vehicle. The invention also relates to an electrical energy store.

At present, interest is focused on electrical energy stores which are used, in particular, as traction batteries for electrically drivable motor vehicles, that is to say hybrid or electric vehicles. Electrical energy stores of this kind usually have a large number of cell modules which are interconnected with each other and are arranged in an accommodation space in a store housing of the electrical energy store. The cell modules in turn have a large number of storage cells which are interconnected with each other.

The situation may arise here of a faulty storage cell degassing owing to a thermal event, for example a short circuit within the cell, and as a result introducing heat and particles into the accommodation space. These particles may accumulate at critical points, for example on other storage cells, and lead to insulation faults, arcs and short circuits there. In order to prevent this, DE 10 2018 213 066 A1 for example discloses introducing a fire-retardant and electrically insulating sealer into the closed store housing through an injection opening until intermediate spaces present in the store housing are surrounded by the sealer. Completely filling the store housing with a sealer of this kind renders maintenance and recycling of the electrical energy store difficult.

An object of the present invention is to provide a particularly simple and easy-to-maintain solution for protecting storage cells of an electrical energy store.

According to the invention, this object is achieved by a cell module and an electrical energy store having the features according to the present disclosure. The description and the figures also relate to advantageous embodiments of the invention.

A cell module according to the invention for an electrical energy store of a motor vehicle has at least two cell packs which are interconnected with each other and each have a plurality of storage cells which are interconnected with each other. The cell module also comprises a cell module frame having at least two frame portions, which are arranged adjacent to each other, for receiving one cell pack each. The cell module also has a cover, which is arranged on the cell module frame, for covering the frame portions, and at least one heat-resistant, firewall-like barrier. This barrier is arranged on the cover so as to overlap with a transition between the two cell packs and is designed to divide a space which is adjacent to the cover into at least two fire compartments in order to prevent a hot gas of a cell pack that is flowing into the space from spreading to an adjacent cell pack.

The invention also relates to an electrical energy store for a motor vehicle, having a store housing and at least one cell module according to the invention. The at least one cell module is arranged in an accommodation space in the store housing, wherein the at least one barrier extends, starting from the cover, as far as a housing wall of the store housing and is supported on the housing wall. The electrical energy store is, in particular, a high-voltage energy store and forms a traction battery for the electrified motor vehicle. The cell module has at least two cell packs which are interconnected with each other. Each cell pack has a plurality of storage cells or battery cells which are interconnected with each other and can be designed, for example, as round cells, pouch cells or prismatic cells. The storage cells are preferably designed as prismatic cells and stacked along a stacking direction to form a cell pack in the form of a cell stack or cell bar. The stacking direction corresponds to a longitudinal direction of the cell stack here. At least two cell stacks are arranged next to one another in the transverse direction transverse to the stacking direction, and therefore the cell module is designed as a multi-row cell module. The cell module preferably has two cell stacks which are arranged next to each other, and therefore the cell module is of double-row design.

Here, the prismatic cells have a flat parallelepipedal cell housing with a cell housing front wall, a cell housing rear wall, cell housing side walls, a cell housing cover and a cell housing bottom. The cell housing also has cell terminals or cell poles for contacting a galvanic element in the cell housing. The cell terminals are arranged, for example, on the cell housing cover. The cell housing also has a degassing element, for example a bursting membrane which is designed to discharge from the cell housing a hot gas created within the cell housing in the event of a fault in order to reduce pressure. The degassing element can likewise be arranged on the cell housing cover, for example between the two cell terminals.

The cell packs are arranged in frame portions of a cell module frame here. In the case of pouch cells or prismatic cells, the storage cells are also pressed in the stacking direction by the cell module frame. For this purpose, in a first variant, the cell module frame has, for each frame portion, two pressure plates to be arranged on end sides, which are situated opposite each other in the longitudinal direction, of the cell stack and two tie rods, which are connected to the pressure plates, to be arranged on side regions, which are situated opposite each other in the transverse direction, of the cell stack. The two tie rods, which are arranged on mutually facing inner side regions of the cell stacks, are mechanically connected to each other in order to form the cell module frame. In a second variant, the cell module frame has two pressure plates, which extend over the end sides, which are arranged next to each other in the transverse direction, of the cell stacks and three tie rods, which are connected to the two pressure plates, to be arranged on side regions of the cell stack. Here, one tie rod is arranged between the two cell stacks on the inner, mutually facing side regions of the cell stacks and two tie rods are arranged on the outer side regions of the cell stacks.

Here, the end sides of the cell stack are formed by the cell housing front wall of a first storage cell in the cell stack and the cell housing rear wall of a last storage cell in the cell stack. Side regions of the cell stack are formed by the cell housing side walls of the storage cells. A top side of the cell stack is formed by the cell housing covers of the storage cells and a bottom side of the cell stack is formed by the cell housing bottoms of the storage cells. Here, in the first variant, each cell stack is arranged in a cell pack frame which forms the respective frame portion and has two pressure plates and two tie rods. The two cell pack frames are then mechanically connected to form the cell module frame, for example by way of the two mutually facing tie rods of the cell pack frames being adhesively bonded. In the second variant, the two cell stacks share the two pressure plates and one of the tie rods which extends between the two cell stacks and rests against the inner side regions of the two cell stacks. The cell module frame is therefore divided into the frame portions by the tie rod running centrally between the cell stacks.

Here, the cell module frame is covered by a cover which completely covers, in particular, those sides of the cell stacks that have the degassing elements. The cover can be formed, for example, from a plurality of layers and contain a plastic layer and a heat protection layer, for example composed of mica. In particular, the cover is fastened to the cell module frame.

A cell-contacting system is arranged between the cover and the cell packs in order to interconnect the storage cells of the respective cell packs and in order to interconnect the cell packs. The cell-contacting system can have an electrically insulating carrier, for example a plastic carrier, which is designed to hold electrical connectors or contact elements. These connectors are electrically and mechanically connected, for example welded, to the cell poles. For example, the cell-contacting system can have a plurality of cell connectors for each cell pack for electrically connecting the storage cells and a pack connector for interconnecting the cell packs. For example, the interconnection in the double-row cell module can be made in such a way that the two cell stacks are interconnected by a connector which runs in the transverse direction across the transition between the cell stacks and electrically connects a storage cell of one cell stack to a storage cell of the other, adjacent cell stack.

Here, the at least two cell packs, the cell module frame, the cover and the cell-contacting system form, in particular, a ready-to-fit assembly. In other words, the cell module is designed as a structural unit which can be arranged in the accommodation space in the store housing of the electrical energy store in one assembly step. Here, the at least one cell module is arranged in the accommodation space, which is delimited by housing walls of the store housing, in such a way that a space is formed between the cover and a further store component, which is located above the cell module in the vertical direction, of the energy store, for example one of the housing walls of the store housing. The housing wall adjoining the space can be, for example, a housing cover of the store housing or an intermediate bottom for dividing the accommodation space into a plurality of planes which lie one above the other in the vertical direction.

The situation may arise here of a storage cell of one of the cell packs degassing due to a fault and as a result discharging hot gas through the cover into the space, which is located above the cover, in the store housing. In order to prevent heat and particles, which are transported by the hot gas, from damaging the adjacent cell pack, the at least one heat-resistant barrier is provided, which divides the space above the cover in the region of the transition between the two cell packs into the fire compartments or fire sections. Here, the barrier extends in the longitudinal direction in particular over an entire length of the cell pack and, starting from the cover, as far as the further store component, which is arranged above the cell module, of the energy store, for example the housing wall, in the longitudinal direction. In the case of the cell stacks in which the degassing elements are arranged in each case in one strip-like region, which extends in the longitudinal direction, on the top side of the respective cell stack, the barrier extends at most as far as the strip-like regions in the transverse direction. The barrier therefore does not completely cover the cover, in particular does not cover the cover in the region of the degassing elements of the storage cells situated beneath it. As a result, the barrier forms a firewall-like separating wall between the cell packs which ensures, at least over a predetermined period of time, that the heat and particles remain in the respective fire section which belongs to the cell pack with the storage cell that is degassing.

The heat-resistant barrier is preferably formed from a compressible material and thus forms an auxiliary joining part for a press-fit connection between the cover and the housing wall of the store housing. The barrier is therefore pressed-in between the housing wall of the store housing and the cover and thus pushes the cover against the cell packs. As a result, the barrier additionally also presses the layers of the cover, and therefore it is possible to prevent the heat protection layer from becoming detached, for example.

The at least one barrier can be designed, for example, as a prefabricated part which is fastened to the cover. For example, the prefabricated part can be a fire protection mat. This fire protection mat can be formed, for example, from glass fiber or aramid fiber. The prefabricated part can also be a ceramic plate. A prefabricated part of this kind can be pre-fitted, for example adhesively bonded, to the cover, and therefore the entire cell module including the barrier is designed as a ready-to-fit assembly. As an alternative to this, the at least one barrier can be designed as a solid foam wall, for example composed of a polyurethane foam, which is applied to the cover only during final assembly of the energy store, for example. For this purpose, the cell module is arranged, for example, in the accommodation space and the barrier is applied to the cover. For example, the cover is partially coated, for example sprayed, with the foam for this purpose. The housing wall of the store housing is then arranged above the cell module on the barrier.

The embodiments and advantages of the embodiments presented with reference to the cell module according to the invention correspondingly apply to the electrical energy store according to the invention.

Further features of the invention can be found in the claims, the figures and the description of the figures. The features and combinations of features that are cited in the description above and the features and combinations of features that are cited in the description of the figures below and/or that are shown in the figures can be used not only in the respectively indicated combination but also in other combinations or else on their own.

The invention will now be described in greater detail on the basis of one preferred exemplary embodiment and with reference to the drawings.

### BRIEF DESCRIPTION OF THE DRAWINGS

FIG. 1 is a perspective illustration of a cell module for an electrical energy store; and

FIG. 2 is a schematic illustration of a plan view of cell packs of the cell module.

### DETAILED DESCRIPTION OF THE DRAWINGS

In the figures, identical and functionally identical elements are provided with the same reference signs.

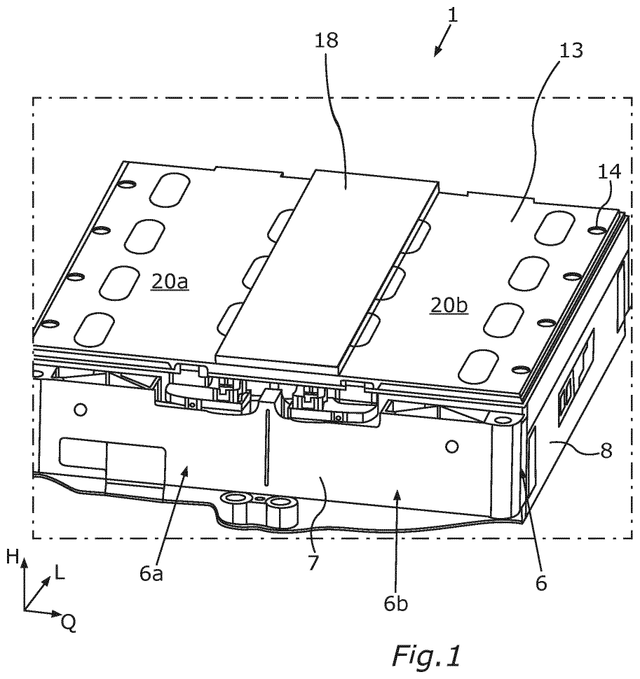

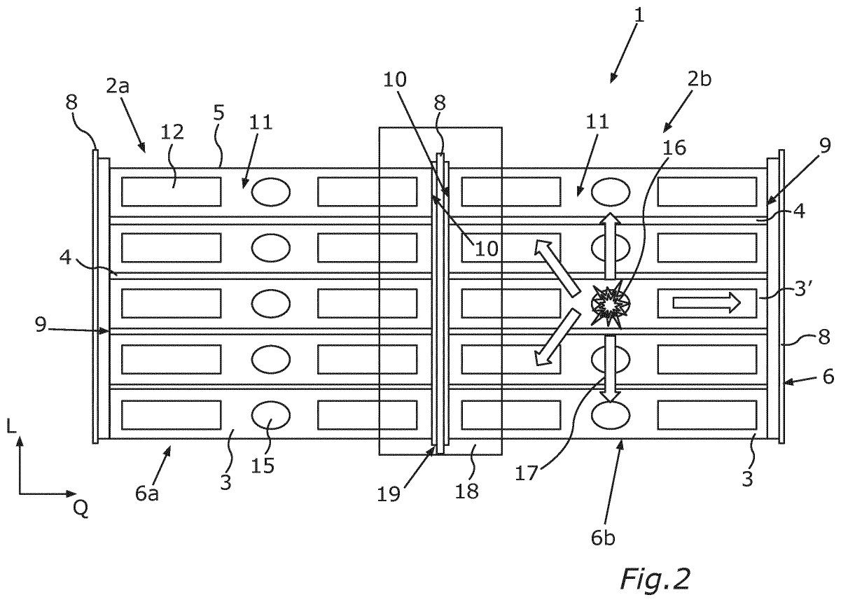

FIG. 1 and FIG. 2 show a cell module 1 for an electrical energy store of a motor vehicle. Here, the cell module 1 has two cell packs 2a, 2b with a plurality of storage cells 3, 3′. The storage cells 3, 3′ are prismatic battery cells here, and therefore the cell packs 2a, 2b are designed as cell stacks or cell bars. The storage cells 3, 3′ are stacked in the longitudinal direction L, wherein the insulation layers 4 are arranged between the storage cells 3, 3′ for insulating metal cell housings 5 of the storage cells 3, 3′. The two cell packs 2a, 2b are arranged next to each other in the transverse direction Q. The cell packs 2a, 2b are arranged in frame portions 6a, 6b of a cell module frame 6. Here, the cell module frame 6 has two pressure plates 7 which are arranged on end sides, which are situated opposite each other in the longitudinal direction L, of the cell packs 2a, 2b. Here, one pressure plate 7 is arranged on the front end sides of the two cell packs 2a, 2b and one pressure plate 7 is arranged on the rear end sides of the two cell packs 2a, 2b. Therefore, each pressure plate 7 extends in the transverse direction Q over the two cell packs 2a, 2b and therefore over the two frame portions 6a, 6b.

Here, the cell module frame 6 also has three tie rods 8 which extend in the longitudinal direction L and are arranged on side regions 9, 10 of the cell packs 2a, 2b. Each tie rod 8 is mechanically connected, for example welded, to the two pressure plates 7. Here, one tie rod 8 is arranged on an outer side region 9 of the first cell pack 2a. One tie rod 8 is arranged on an inner side region 10 of the first cell pack 2a and an inner side region 10 of the second cell pack 2b and therefore runs centrally between the two cell packs 2a, 2b. One tie rod 8 is arranged on an outer side region 9 of the second cell pack 2b. The first frame portion 6a is therefore delimited by one half of the two pressure plates 7 and two tie rods 7, and the second frame portion 6b is delimited by the second half of the two pressure plates 7 and two tie rods 7.

A cell-contacting system, not shown here, can be arranged on top sides 11 of the cell packs 2a, 2b, cell terminals 12 of the storage cells 3, 3′ also being located on the top sides, in order to interconnect the storage cells 3, 3′ of the respective cell pack 2a, 2b. The cell-contacting system is covered by a cover 13 which completely covers the top sides 11 of the cell packs 2a, 2b and therefore the frame portions 6a, 6b. The cover 13 is fastened to the cell module frame 6 by screws 14 here. Degassing elements 15 of the storage cells 3, 3′, by which degassing elements a hot gas 17 can escape from the cell housing 5 of the storage cell 3′ in the event of a fault 16, as shown using the storage cell 3′ of the second cell pack 2b, also located on the top sides 11 of the cell packs 2a, 2b. This hot gas 17, which passes through the cover 13, transports heat and particles from the cell housing 5 into a space above the cover 13.

In order to prevent the hot gas 17 from the faulty storage cell 3′ of the second cell pack 2b from damaging the first cell pack 2a, for example by way of the particles causing short circuits between the storage cells 3, 3′ of the two cell packs 2a, 2b, the cell module 1 has a heat-resistant barrier 18 which extends in the vertical direction H starting from the cover 13. In particular, the barrier 18 extends as far as a housing wall of a store housing of the electrical energy store in the vertical direction H, the housing wall being arranged at a distance from the cover 13 and so as to overlap with the cover 13 when the cell module 1 is located in the store housing. The barrier 18 is formed, in particular, from a compressible material and is therefore pressed-in between the cover 13 and the housing wall. The barrier 18 can be designed, for example, as a mat composed of glass fiber or aramid fiber, a polyurethane foam, a ceramic plate or else by a sprayable fire protection foam. The barrier 18 extends at most as far as the degassing elements 15 of the cell packs 2a, 2b in the transverse direction Q. Therefore, the barrier 18 does not completely cover the cover 13, but rather forms a kind of fire protection wall in the region of a transition 19 between the cell packs 2a, 2b. The barrier 18 extends over an entire length of the cell module 1 in the longitudinal direction L.

The barrier 18 divides the space into two fire compartments 20a, 20b, wherein the first fire compartment 20a is arranged above the first cell pack 2a and therefore forms a degassing chamber for the storage cells 3 of the first cell pack 2a, and wherein the second fire compartment 20b is arranged above the second cell pack 2b and therefore forms a degassing chamber for the storage cells 3, 3′ of the second cell pack 2b. Here, the fire compartments 20a, 20b are closed off in such a way that they do not permit passage of any hot gas from one fire compartment 20a, 20b to the respectively other fire compartment 20b, 20a, at least for a predetermined period of time.

1-12. (canceled)

13. A cell module for an electrical energy store of a motor vehicle, comprising:
at least two cell packs that are interconnected with each other and each have a plurality of storage cells that are interconnected with each other;
a cell module frame having at least two frame portions that are arranged adjacent to each other and configured to receive one cell pack each;
a cover that is arranged on the cell module frame and configured to cover the frame portions; and
at least one heat-resistant, firewall-type barrier that is arranged on the cover so as to overlap with a transition between the two cell packs and is configured to divide a space which is adjacent to the cover into at least two fire compartments in order to prevent a hot gas of a first cell pack of the at least two cell packs that flows into the space from spreading to an adjacent second cell pack of the at least two cell packs.

14. The cell module according to claim 13, comprising:
a cell-contacting system arranged between the cover and the at least two cell packs and configured to interconnect the plurality of storage cells of the at least two cell packs and to interconnect the at least two cell packs.

15. The cell module according to claim 14, wherein
the at least two cell packs, the cell module frame, the cover, and the cell-contacting system form a ready-to-fit assembly.

16. The cell module according to claim 13,
wherein each cell pack is configured as a cell stack comprising prismatic storage cells that are stacked one on the other along a longitudinal direction, and
wherein at least two cell stacks are arranged next to one another in a transverse direction in order to form a multi-row cell module.

17. The cell module according to claim 16,
wherein the cell module frame comprises, for each frame portion:
two pressure plates arranged on end sides, which are situated opposite each other in the longitudinal direction of each respective cell stack; and
two tie rods, which are connected to the pressure plates, and arranged on side regions, which are situated opposite each other in the transverse direction of each respective cell stack,
wherein the two tie rods, which are arranged on mutually facing inner side regions of the cell stacks, are mechanically connected to each other in order to form the cell module frame.

18. The cell module according to claim 16,
wherein the cell module frame comprises:
two pressure plates that extend over the two frame portions, and are arranged on end sides, which are situated opposite each other in the longitudinal direction of the cell stacks; and
three tie rods that are connected to the two pressure plates, and are arranged on side regions, which are situated opposite each other in the transverse direction of the cell stacks,
wherein one tie rod of which is arranged between two cell stacks on an inner, mutually facing side regions of the cell stacks, and two tie rods of which are arranged on outer side regions of the cell stacks.

19. The cell module (1) according to claim 16,
wherein the storage cells each have a degassing element, each degassing element being arranged on a side of the storage cells that faces the cover of the respective cell stack in a strip-like region which extends along the longitudinal direction, and
wherein the at least one barrier extends at most as far as the strip-like regions in the transverse direction and over an entire length of the cell stack in the longitudinal direction.

20. The cell module according to claim 13,
wherein the heat-resistant barrier is formed from a compressible material and an auxiliary joining part for a press-fit connection between the cover and a housing wall of a store housing of the electrical energy store.

21. The cell module according to claim 13,
wherein the at least one barrier is designed as a prefabricated part that is fastened to the cover.

22. The cell module according to claim 21,
wherein the prefabricated part is a fire protection mat.

23. The cell module according to claim 13,
wherein the at least one barrier is designed as a solid foam wall.

24. An electrical energy store for a motor vehicle, comprising:
a store housing; and
the cell module according to claim 13,
wherein the one cell module is arranged in the store housing and the at least one barrier extends, starting from the cover, as far as a housing wall of the store housing and is supported on the housing wall.
